(19) United States
(12) Patent Application Publication
(10) Pub. No.: US 2026/0074999 A1
(43) Pub. Date: Mar. 12, 2026

(54) SYSTEMS AND METHODS FOR AUTOMATICALLY SHIFTING TRAFFIC ACROSS NETWORK REGIONS

(71) Applicant: Netflix, Inc., Los Gatos, CA (US)

(72) Inventors: Arthur Gonigberg, San Jose, CA (US); Justin Robert Guerra, Boulder, CO (US); Ryan Daniel Schroeder, Los Gatos, CA (US); Phelps Williams, Los Gatos, CA (US); Niosha Behnam, Campbell, CA (US)

(21) Appl. No.: 18/830,427

(22) Filed: Sep. 10, 2024

(51) Int. Cl. H04L 47/125; H04L 43/0823; H04L 47/2425

(52) U.S. Cl. CPC H04L 47/125; H04L 43/0847; H04L 47/2425

(57) ABSTRACT

A computer-implemented method for automatically shifting traffic across network regions may include detecting an error rate of requests for at least one service in a specific region of a network. In one example, the computer-implemented method may also include determining that the error rate exceeds a threshold in the specific region of the network. Additionally or alternatively, the computer-implemented method may include automatically shifting traffic associated with the at least one service from the specific region to at least one additional region of the network in response to determining that the error rate exceeds the threshold. Various other methods, systems, and computer-readable media are also disclosed.

### BACKGROUND

Digital content streaming is an increasingly popular activity with viewers turning to streaming platforms to watch movies, episodic content, and even live events. In some examples, a streaming platform may provide high availability and/or redundancy via multiple network regions capable of implementing the same services. In one example, one or more of the network regions may be scaled and/or configured with headroom to accommodate traffic shifted from another one of the network regions in the event of a traffic spike. Unfortunately, shifting traffic among those network regions may be somewhat problematic and/or may be complicated by uncertainties. For example, some traffic shifts may be manually initiated by administrators using subjective decision-making techniques under time pressure. The instant disclosure, therefore, identifies and addresses a need for to provide and/or support high availability of services.

### SUMMARY

As will be described in greater detail below, the present disclosure describes systems and methods for automatically shifting traffic across network regions. For example, a computer-implemented method for accomplishing such a task may include detecting an error rate of requests for at least one service in a specific region of a network. In this example, the computer-implemented method may include determining that the error rate exceeds a threshold in the specific region of the network. Additionally or alternatively, the computer-implemented method may include automatically shifting traffic associated with the at least one service from the specific region to at least one additional region of the network in response to determining that the error rate exceeds the threshold.

In some examples, the computer-implemented method may include rerouting the traffic to a plurality of additional regions. In one example, the computer-implemented method may include balancing the traffic across the plurality of additional regions. Additionally or alternatively, the computer-implemented method may include determining the error rate by detecting a certain amount of retry attempts for the at least one service.

In some examples, the computer-implemented method may include throttling the retry attempts in response to determining that the error rate exceeds the certain threshold. In one example, the traffic associated with the at least one service may include and/or represent lower-priority traffic and higher-priority traffic, and the computer-implemented method may include throttling retry attempts associated with the lower-priority traffic. Additionally or alternatively, the computer-implemented method may include throttling the retry attempts associated with the lower-priority traffic without throttling retry attempts associated with the higher-priority traffic.

In some examples, the computer-implemented method may include tracking error rates of requests across a plurality of regions of the network, wherein the plurality of regions of the network comprises the specific region of the network. In one example, the computer-implemented method may include determining the threshold in the specific region based at least in part on the error rates of requests across the plurality of regions of the network. In certain implementations, each region of the network may include and/or represent a plurality of availability zones and/or data centers that support high availability of the at least one service. Additionally or alternatively, the requests may include and/or represent application programming interface (API) requests for the at least one service.

In some examples, the traffic associated with the at least one service may include and/or represent lower-priority traffic and higher-priority traffic. In one example, the computer-implemented method may include automatically shifting the lower-priority traffic from the specific region to the at least one additional region and maintaining the higher-priority traffic in the specific region despite the error rate exceeding the threshold.

In some examples, the computer-implemented method may include calculating estimates of latencies likely to result from shifting the traffic from the specific region to a plurality of regions of the network, wherein the plurality of regions comprises the specific region. In one example, the computer-implemented method may include identifying, within the estimates of latencies, an estimate associated with latency likely to result from shifting the traffic from the specific region to the at least one additional region. In this example, the computer-implemented method may include determining that the estimate associated with the latency satisfies an acceptable-latency threshold. Additionally or alternatively, the computer-implemented method may include automatically shifting the traffic associated with the at least one service from the specific region to the at least one additional region in response to determining that the error rate exceeds the threshold and that the estimate associated with the latency satisfies the acceptable-latency threshold.

A corresponding system may include at least one interface and circuitry communicatively coupled to the interface. In some examples, the interface may be communicatively coupled to a specific region of a network. In one example, the circuitry may be configured to detect, via the interface, an error rate of requests for at least one service in the specific region of the network. In this example, the circuitry may be further configured to determine that the error rate exceeds a threshold in the specific region of the network. Additionally or alternatively, the circuitry may be configured to automatically shift traffic associated with the at least one service from the specific region to at least one additional region of the network in response to determining that the error rate exceeds the threshold.

A corresponding non-transitory computer-readable medium may include one or more computer-executable instructions. In one example, when executed by a processor of a computing device, such computer-executable instructions may cause the processor to (1) detect an error rate of requests for at least one service in a specific region of a network, (2) determine that the error rate exceeds a threshold in the specific region of the network, and/or (3) automatically shift traffic associated with the at least one service from the specific region to at least one additional region of the network in response to determining that the error rate exceeds the threshold.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for automatically shifting traffic across network regions in accordance with one or more implementations of this disclosure.

FIG. 2 illustrates an exemplary system for automatically shifting traffic across network regions in accordance with one or more implementations of this disclosure.

FIG. 3 illustrates an exemplary system for automatically shifting traffic across network regions in accordance with one or more implementations of this disclosure.

FIG. 4 illustrates an exemplary system for automatically shifting traffic across network regions in accordance with one or more implementations of this disclosure.

FIG. 5 illustrates an exemplary method for automatically shifting traffic across network regions in accordance with one or more implementations of this disclosure.

FIG. 6 illustrates a block diagram of an exemplary content distribution ecosystem.

FIG. 7 illustrates a block diagram of an exemplary distribution infrastructure within the content distribution ecosystem shown in FIG. 6.

FIG. 8 illustrates a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure describes various systems and methods for automatically shifting traffic across network regions. As will be explained in greater detail below, embodiments of the present disclosure may involve detecting an error rate for a service and/or a certain amount of retry attempts for the service in a specific region of a network. Some embodiments of the present disclosure may also involve determining that the error rate and/or the number of retry attempts exceeds a certain threshold. Such embodiments may further involve automatically shifting traffic associated with the at least one service from the specific region to at least one additional region of the network.

As a specific example, a digital streaming platform may distribute traffic across multiple different regions of a network. In one example, such network regions may correspond to and/or represent different geographical areas (e.g., different states, countries, continents, etc.). In this example, each network region may maintain and/or preserve a certain amount of headroom to accommodate and/or absorb intermittent traffic spikes.

For example, the digital streaming platform may provide a live streaming event for which the number of viewers is highly variable and/or unpredictable. In this example, the digital streaming platform may source and/or originate content for the live streaming event from one of those regions of the network. If traffic for the live streaming event spikes to the point of exhausting and/or consuming the headroom maintained by that network region, some or all of the traffic for the live streaming event may fail over from that network region to at least one additional network region. Although this example is described in the context of a live streaming event, other examples may involve and/or be directed to regular video on-demand (VOD) implementations.

As a specific example, if traffic for the live streaming event spikes to exceeds the headroom maintained by the original network region, the digital streaming platform and/or the network may implement and/or apply a traffic-control mechanism that automatically shifts some or all the traffic to an additional network region to accommodate the spike. In one example, the traffic-control mechanism may focus on and/or reconfigure the origin (e.g., an availability zone and/or data center included in the original network region) of the content. For example, the content may be delivered, sourced, and/or provided by a single-origin service that is instantiated and/or available in each of the network regions.

In one example, the digital streaming platform and/or the network may implement a system that monitors and/or tracks the error rates of requests and/or retry attempts for a single-origin service involved in the live streaming event. In this example, if the error rate(s) of service requests and/or corresponding retry attempts exhaust and/or consume the headroom of the original network region, then the system may automatically shift some or all of the traffic corresponding to such requests and/or retry attempts to the additional network region. By doing so, the system may be able to relieve the burden on the original network region by leveraging the headroom available in the additional network region to accommodate the service requests and/or retry attempts involved in the live streaming event. Accordingly, the system may facilitate, provide, and/or support granular failover that does not involve evacuating the entire original network region but, rather, automatically shifts and/or balances the traffic load across the original and additional network regions in real-time in response to unexpected spikes. As a result, the system may provide and/or offer the failing and/or overloaded original network region an opportunity to recover.

Features from any of the implementations described herein may be used in combination with one another in accordance with the general principles described herein. These and other implementations, features, and advantages will be more fully understood upon reading the following detailed description in conjunction with the accompanying drawings and claims.

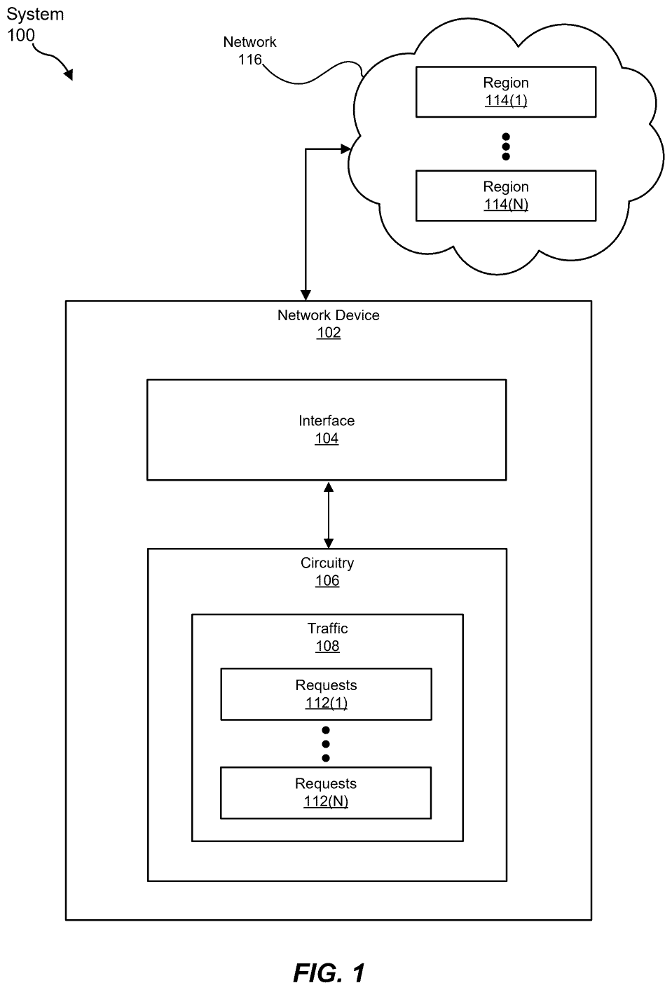

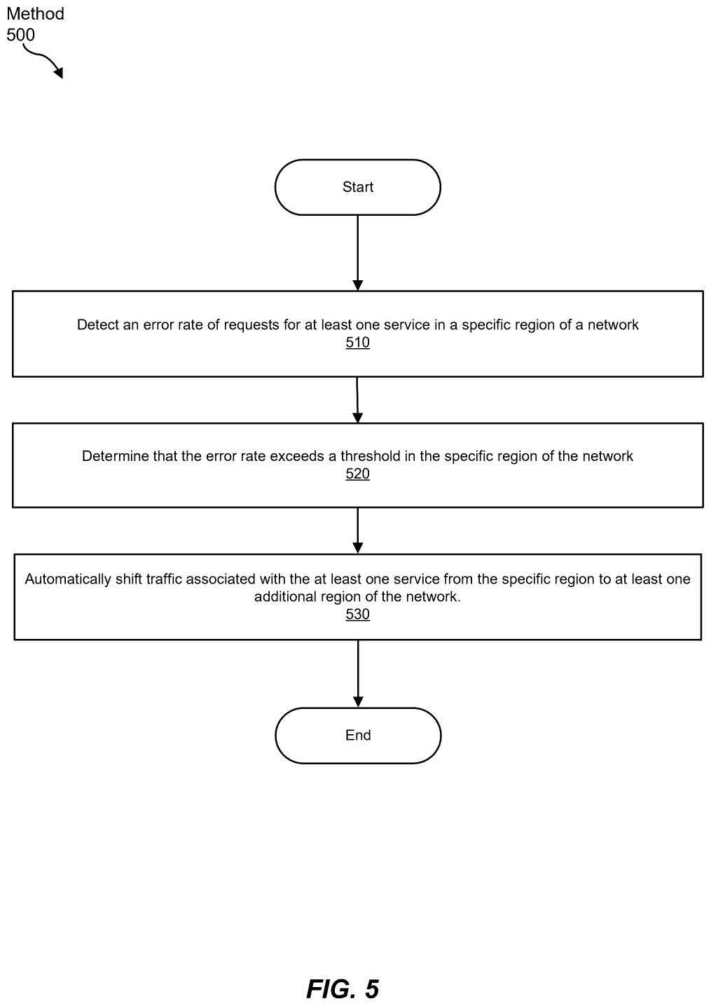

The following will provide, with reference to FIGS. 1-4 and 6-8, detailed descriptions of exemplary devices, systems, and corresponding implementations or configurations that facilitate and/or support automatically shifting traffic across network regions. The following will also provide, with reference to FIG. 5, examples of methods for automatically shifting traffic across network regions.

FIG. 1 illustrates an exemplary system 100 for automatically shifting traffic across network regions. As illustrated in FIG. 1, system 100 may include and/or represent a network device 102 and/or a network 116. In some examples, network device 102 may include and/or represent an interface 104 and/or circuitry 106. In one example, interface 104 may be communicatively coupled to circuitry 106 and/or network 116. In this example, circuitry 106 may execute and/or implement certain features and/or modules for automatically shifting traffic 108 across network regions. In certain implementations, traffic 108 may include and/or represent one or more requests 112(1)-(N) for one or more services provided, sourced, and/or implemented by network 116. Although not necessarily illustrated in this way in FIG. 1, network device 102 may be included in and/or represent part of network 116.

In some examples, network 116 may include and/or represent regions 114(1)-(N) that facilitate, provide, and/or support high availability and/or redundancy of certain services. In this example, regions 114(1)-(N) may each include, represent, and/or implement one or more availability zones, data centers, and/or origins of such services. In certain implementations, these services may be responsible for delivering and/or providing digital content associated with and/or involved in a video streaming platform.

In some examples, circuitry 106 may monitor, track, and/or detect the error rate of requests 112(1)-(N) for one or more services provided in regions 114(1)-(N). In one example, requests 112(1)-(N) may include and/or represent API requests serviced by and/or in regions 114(1)-(N). Additionally or alternatively, circuitry 106 may monitor, track, and/or detect the amount of retry attempts initiated in response to errors arising from the failed requests for such services. Circuitry 106 may also monitor, track, and/or detect latencies of the requests and/or retry attempts across regions 114(1)-(N). In one example, circuitry 106 may throttle, limit, and/or reduce such retry attempts based at least in part on certain criteria. For example, circuitry 106 may throttle, limit, and/or reduce retry attempts made in connection with low-priority traffic and/or services.

In some examples, circuitry 106 may determine that the error rate of requests for a certain service exceeds an acceptable threshold. For example, region 114(1) may receive more requests for a service than region 114(1) is able to handle, support, and/or perform. In this example, those requests may result in and/or cause errors due at least in part to the inability of region 114(1) to handle, support, and/or perform such requests. Additionally or alternatively, such requests may constitute and/or represent control-plane traffic, routing-plane traffic, and/or API traffic (e.g., exchanged during bootstrapped sessions), as opposed to data-plane traffic and/or forwarding-plane traffic. In certain implementations, circuitry 106 may determine, calculate, and/or identify the threshold of an excessive error rate for region 114(1) based at least in part the error rates of requests across regions 114(1)-(N).

In some examples, circuitry 106 may automatically shift, reroute, redistribute, fail over, and/or balance traffic associated with the service in response to determining that the error rate exceeds the acceptable threshold. For example, circuitry 106 may automatically shift some or all of the traffic corresponding to the requests that caused the excessive error rate in region 114(1) to region 114(N). In one example, circuitry 106 may balance the traffic across multiple regions of network 116 by rerouting requests for the service across multiple regions of network 116 that have sufficient headroom. In certain implementation, the shifting and/or rerouting of traffic may be controlled and/or informed by certain policies (e.g., scaling, failover, and/or policies).

In some examples, circuitry 106 may base the decision to automatically shift and/or reroute certain traffic on multiple factors. Examples of such factors include, without limitation, the error rate of requests involved in the traffic at issue, the priority level of the traffic at issue and/or the corresponding service, whether any and/or how many retry attempts have been made after failed requests, the amount of latency that would result from the traffic shift and/or reroute, combinations or variations of one or more of the same, and/or any other suitable factors.

In some examples, a policy may cause circuitry 106 to automatically shift and/or reroute the traffic somewhat evenly across regions 114(1)-(N). For example, if network 116 includes and/or represents regions, then the policy may cause circuitry 106 to automatically shift and/or reroute some or all of the affected traffic from the failing and/or overloaded region to the other regions in a substantially even and/or balanced distribution. Additionally or alternatively, the policy may cause circuitry 106 to automatically shift and/or reroute some or all of the affected traffic from the failing and/or overloaded region to a geographically proximate region (e.g., the nearest region).

In some examples, network device 102 may include and/or represent any type or form of physical computing device and/or network of computing devices capable of reading computer-executable instructions and/or handling network traffic via interface 104. Examples of network device 102 include, without limitation, network devices, routers (such as provider edge routers, hub routers, spoke routers, autonomous system boundary routers, and/or area border routers), rackmount telecommunications devices, switches, hubs, modems, bridges, repeaters, gateways (such as broadband network gateways), multiplexers, network adapters, network interfaces, client devices, laptops, tablets, desktops, servers, variations or combinations of one or more of the same, and/or any other suitable systems.

In some examples, interface 104 may include and/or represent any type or form of physical or virtual interface capable of and/or involved in sending and/or receiving traffic (e.g., requests) in connection with one or more services. In one example, interface 104 may include and/or represent a transmitter, a receiver, and/or a transceiver. In this example, interface 104 may operate via electrical, optical, and/or electromagnetic communications and/or signaling. Additionally or alternatively, interface 104 may include and/or represent a wireless and/or wired communication link or connection. Examples of interface 104 include, without limitation, Small Form-Factor (SFP) pluggable modules, Quad SFP (QSFP) pluggable modules, QSFP Double Density (QSFP-DD) pluggable modules, synchronous optical networking (SONET) interfaces, Ethernet modules, optical fibre channel modules, variations or combinations of one or more of the same, and/or any other suitable interfaces.

In some examples, circuitry 106 may include and/or represent one or more electrical and/or electronic circuits capable of processing, applying, modifying, transforming, displaying, transmitting, receiving, and/or executing data for system 100. Additionally or alternatively, circuitry 106 may launch, perform, and/or execute certain executable files, code snippets, modules, and/or computer-readable instructions to facilitate and/or support automatically shifting traffic across network regions. Although illustrated as a single unit in FIG. 1, circuitry 106 may include and/or represent a collection of multiple processing units, electrical components, and/or devices that work and/or operate in conjunction with one another. Examples of circuitry 106 include, without limitation, application-specific integrated circuits (ASICs), central processing units (CPUs), processing devices, microprocessors, microcontrollers, graphics processing units (GPUs), field-programmable gate arrays (FPGAs), systems-on-chips (SoCs), parallel accelerated processors, tensor cores, integrated circuits, chiplets, optical modules, receivers, transmitters, transceivers, optical modules, portions of one or more of the same, variations or combinations of one or more of the same, and/or any other suitable circuitry.

In some examples, network 116 may include and/or represent any medium and/or architecture capable of facilitating device-to-device communications, data transfer, and/or topology updates. In one example, network 116 may include other nodes and/or computing devices that are not necessarily illustrated and/or labelled in FIG. 1. Network 116 may facilitate communication or data transfer using wireless and/or wired connections. In certain implementations, network 116 may include and/or represent a web services network, such as an AMAZON WEB SERVICES (AWS) network, a GOOGLE CLOUD network, a MICROSOFT AZURE network, etc. Examples of network 116 include, without limitation, an intranet, an access network, a layer 2 network, a layer 3 network, a multiprotocol label switching (MPLS) network, an Internet protocol (IP) network, a heterogeneous network (e.g., layer 2, layer 3, IP, and/or MPLS) network, a wide area network (WAN), a local area network (LAN), a personal area network (PAN), the Internet, power line communications (PLC), a cellular network, portions of one or more of the same, variations or combinations of one or more of the same, and/or any other suitable network. Regions 114(1)-(N) of network 116 may each include and/or represent a segment of network 116 configured and/or deployed in a certain geographic area.

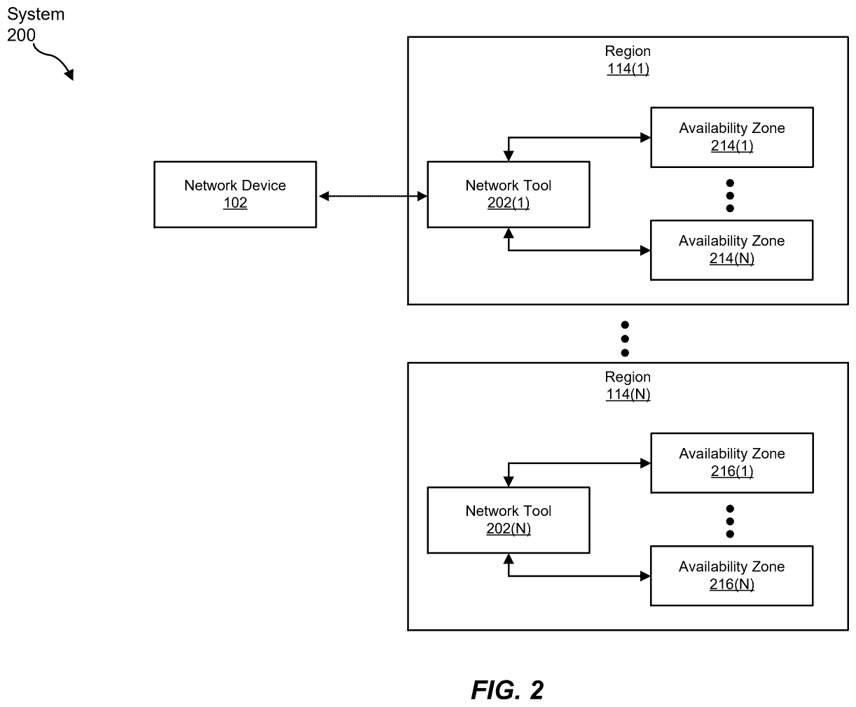

FIG. 2 illustrates an exemplary system 200 that facilitates and/or supports automatically shifting traffic across network regions. In some examples, system 200 may include and/or represent certain components and/or features that perform and/or provide functionalities that are similar and/or identical to those described above in connection with FIG. 1. As illustrated in FIG. 2, region 114(1) may include and/or represent a network tool 202(1) and/or availability zones 214(1)-(N), and/or region 114(N) may include and/or represent a network tool 202(N) and/or availability zones 216(1)-(N). In one example, network tool 202(1) may direct and/or control the flow and/or exchange of traffic between network device 102 and availability zones 214(1)-(N), and/or network tool 202(N) may direct and/or control the flow and/or exchange of traffic between a corresponding network device (e.g., network device 102 or another device that is not necessarily illustrated in FIG. 2) and availability zones 216(1)-(N).

In some examples, network tools 202(1)-(N) may include and/or represent any type of physical or virtual mechanism, device, and/or lever that controls global streaming traffic distribution. In one example, regions 114(1)-(N) may each include and/or implement an instance of one or more of network tools 202(1)-(N) running on one or more computing devices (e.g., network device 102). In this example, one or more of network tools 202(1)-(N) may detect a significantly high number of errors (e.g., failed requests, failed retry attempts, etc.) returned by a certain origin, such as availability zone 214(1), in region 114(1). In response to detecting this significantly high number of errors returned by that origin, one or more of network tools 202(1)-(N) may automatically shift and/or reroute some or all of the traffic associated with those errors to another origin, such as one of availability zones 216(1)-(N), in at least one other region. By doing so, one or more of network tools 202(1)-(N) may shed the traffic load away from the failing or overburdened origin and toward one or more other origins with enough headroom to accommodate such traffic so that the other origins are able to satisfy those requests, thereby preserving the experience of the end-user(s) associated with such traffic.

In some examples, one or more of network tools 202(1)-(N) may focus on and/or modify hostnames (e.g., specific devices) to direct and/or reroute traffic to support single-origin services instantiated and/or available in each of regions 114(1)-(N). In one example, one or more of network tools 202(1)-(N) may constitute and/or represent a proxy mechanism that runs on a virtual private network (VPN) and/or proxies API traffic to and/or from regions 114(1)-(N). Additionally or alternatively, one or more of network tools 202(1)-(N) may facilitate, support, and/or provide granular traffic-shifting (e.g., traffic corresponding to a specific service) to avoid evacuating an entire region.

In some examples, availability zones 214(1)-(N) and/or 216(1)-(N) may each include and/or represent a data center and/or computer system that hosts services for a streaming platform. In one example, an implementation of system 200 may include and/or represent multiple network regions established and/or set up in different geographical areas throughout the world. In this example, each of those network regions may include and/or represent multiple availability zones capable of servicing requests in connection with a streaming platform.

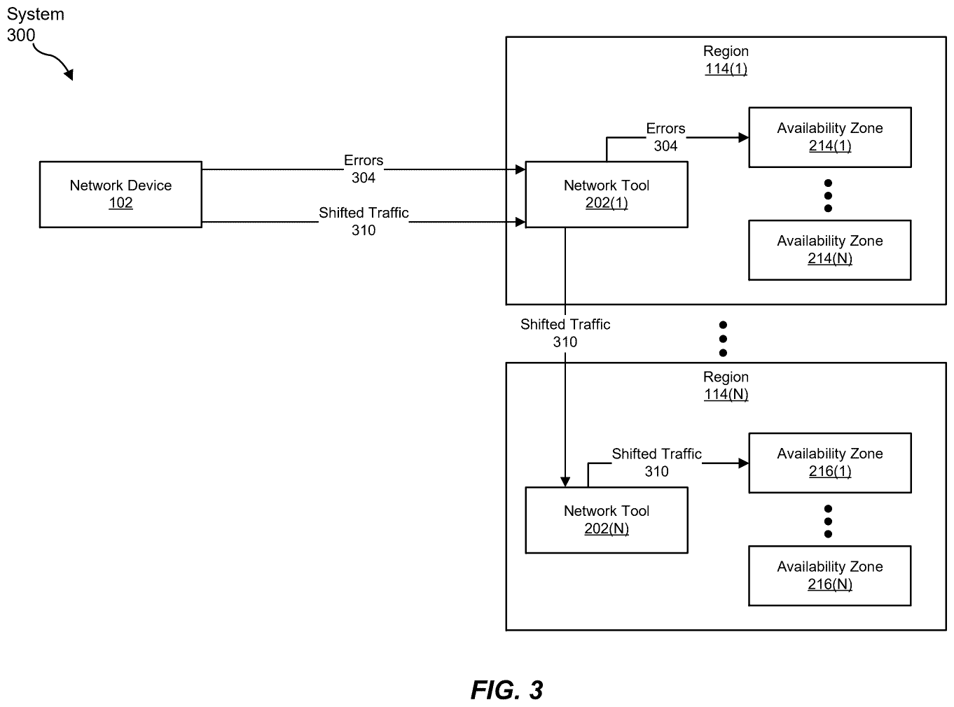

FIG. 3 illustrates an exemplary system 300 that facilitates and/or supports automatically shifting traffic across network regions. In some examples, system 300 may include and/or represent certain components and/or features that perform and/or provide functionalities that are similar and/or identical to those described above in connection with either FIG. 1 or FIG. 2. As illustrated in FIG. 3, network device 102 may submit and/or provide requests and/or retry attempts associated with a single-origin service hosted by availability zone 214(1).

In one example, those requests and/or retry attempts may result in and/or cause errors 304. In this example, network tool 202(1) may determine that the rate of errors 304 is above a certain threshold. Network tool 202(1) may then automatically shift and/or reroute those requests and/or retry attempts to network tool 202(N) implemented in region 114(N). For example, network tool 202(1) may forward shifted traffic 310 to network tool 202(N). In this example, shifted traffic 310 may include and/or represent requests and/or retry attempts that resulted in errors 304 at availability zone 214(1). Network tool 202(N) may then relay and/or forward shifted traffic 310 to one of availability zone 216(1)-216(N) for servicing. In certain implementations, an end-user that initiated the traffic may be unaware of and/or notice no evidence of failover from region 114(1) to region 114(N) despite network tool 202(1) automatically shifting the traffic in response to errors 304.

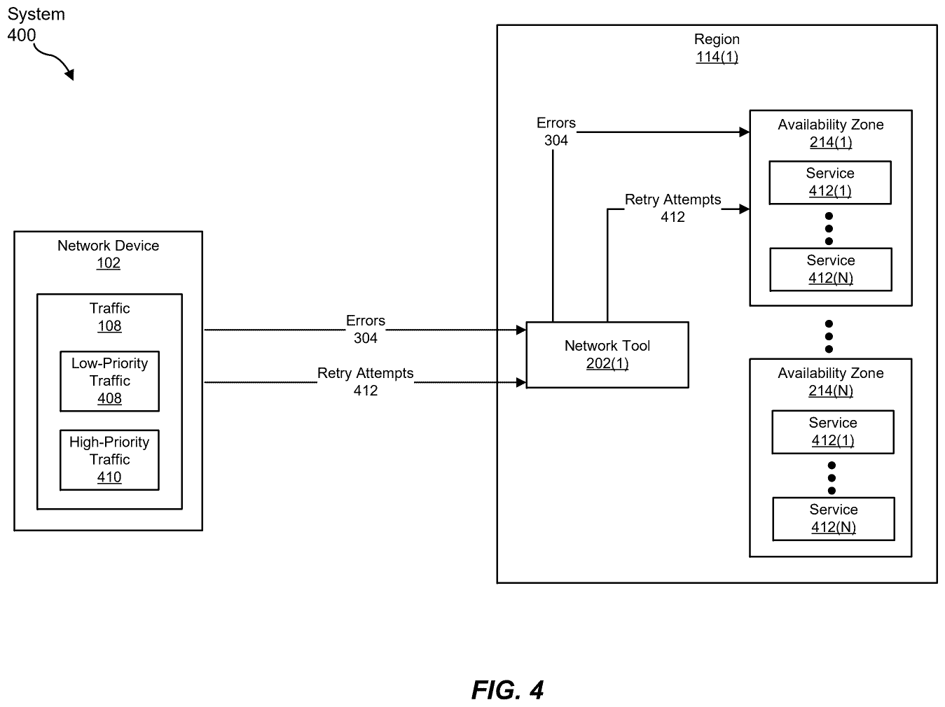

FIG. 4 illustrates an exemplary system 400 that facilitates and/or supports automatically shifting traffic across network regions. In some examples, system 400 may include and/or represent certain components and/or features that perform and/or provide functionalities that are similar and/or identical to those described above in connection with any of FIGS. 1-3. As illustrated in FIG. 4, network device 102 may handle, relay, and/or provide traffic 108 to availability zone 214(1) in connection with one or more services 412(1)-(N), such as an API service and/or application implemented in connection with a digital streaming platform. In one example, availability zones 214(1) may each host, implement, and/or provide an instance of services 412(1)-(N).

In some examples, network device 102 and/or network tool 202(1) may perform and/or submit retry attempts 412 in response to errors 304 arising from failed requests for one or more of services 412(1)-(N) hosted and/or implemented by availability zone 214(1). In such examples, network device 102 and/or network tool 202(1) may throttle retry attempts 412 in response to determining that the error rate of the corresponding requests exceeds a certain threshold. In one example, traffic 108 may include and/or represent low-priority traffic 408 and/or high-priority traffic 410. In this example, network device 102 and/or network tool 202(1) may throttle, limit, and/or reduce retry attempts 412 associated with low-priority traffic 408. However, in this example, network device 102 and/or network tool 202(1) may continue to perform and/or submit retry attempts for high-priority traffic 410 without any throttling.

In some examples, network device 102 and/or network tool 202(1) may automatically shift and/or reroute low-priority traffic 408 from region 114(1) to region 114(N) in response to detecting a spike in errors associated with low-priority traffic 408 and/or high-priority traffic 410. Additionally or alternatively, network device 102 and/or network tool 202(1) may maintain high-priority traffic 410 in region 114(1) to region 114(N) despite the spike in errors associated with low-priority traffic 408 and/or high-priority traffic 410. In other words, network device 102 and/or network tool 202(1) may maintain high-priority traffic 410 in region 114(1) despite the error rate exceeding the threshold.

In some examples, network device 102 and/or network tool 202(1) may calculate, determine, and/or compute estimates of latencies likely to result from shifting traffic from one region to another. In one example, network device 102 and/or network tool 202(1) may identify and/or determine one of those latency estimates that satisfies a threshold of acceptable latency. For example, network device 102 and/or network tool 202(1) may identify and/or determine which of those latency estimates is lowest to shift the traffic from one region to another within network 116. In this example, network device 102 and/or network tool 202(1) may then automatically shift and/or reroute the traffic from region 114(1) to region 114(N) in response to determining that the corresponding error rate exceeds the error-rate threshold and that the latency estimate satisfies the acceptable-latency threshold.

In some examples, the various systems, components, and/or features described in connection with FIGS. 1-4 may include and/or represent one or more additional circuits, components, and/or features that are not necessarily illustrated and/or labeled in FIGS. 1-4. For example, the systems, components, and/or features illustrated in FIGS. 1-4 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, combinations or variations of one or more of the same, and/or any other suitable components. In certain implementations, one or more of these additional circuits, components, and/or features may be inserted and/or applied between any of the existing circuits, components, and/or features illustrated in FIGS. 1-4 consistent with the aims and/or objectives described herein. Accordingly, the couplings and/or connections described with reference to FIGS. 1-4 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In one example, the indirect coupling may include and/or incorporate at least one additional computing device between two computing devices illustrated in any of FIGS. 1-4. In some implementations, one or more components and/or devices illustrated in FIGS. 1-4 may be omitted and/or excluded from any of systems 100, 200, 300, or 400.

FIG. 5 is a flow diagram of an exemplary method 500 for automatically shifting traffic across network regions. In one example, the steps shown in FIG. 5 may be performed by circuitry incorporated and/or implemented in one or more network devices. Additionally or alternatively, the steps shown in FIG. 5 may incorporate and/or involve certain sub-steps and/or variations consistent with the descriptions provided above in connection with FIGS. 1-4.

As illustrated in FIG. 5, method 500 may include and/or involve the step of detecting an error rate of requests for at least one service in a specific region of a network (510). Step 510 may be performed in a variety of ways, including any of those described above in connection with FIGS. 1-4. For example, circuitry incorporated in a network device may detect an error rate of requests for at least one service in a specific region of a network.

Method 500 may also include and/or involve the step of determining that the error rate exceeds a threshold in the specific region of the network (520). Step 520 may be performed in a variety of ways, including any of those described above in connection with FIGS. 1-4. For example, the circuitry incorporated in the network device may determine that the error rate exceeds a threshold in the specific region of the network.

Method 500 may further include and/or involve the step of automatically shifting traffic associated with the at least one service from the specific region to at least one additional region of the network in response to determining that the error rate exceeds the threshold (530). Step 530 may be performed in a variety of ways, including any of those described above in connection with FIGS. 1-4. For example, the circuitry incorporated in the network device may automatically shift traffic associated with the at least one service from the specific region to at least one additional region of the network in response to determining that the error rate exceeds the threshold.

Furthermore, a corresponding non-transitory computer-readable medium is provided that includes one or more computer-executable instructions that, when executed by at least one processor of a computing device, cause the computing device to: access a video frame that includes a plurality of pixels, compute a local distribution for a specified region of the video frame that includes one or more pixels that are likely to include banding artifacts, the computing including: defining a probability range for the local distribution that lies within a predefined interval, using the defined probability range, generating a cumulative vector that includes a distribution of pixels values along a cumulative range of pixels that lie within the specified region of the video frame, and selecting a pseudorandom value within the cumulative range, and apply dithering at least to the specified region of the video frame using the selected pseudorandom values within the cumulative range.

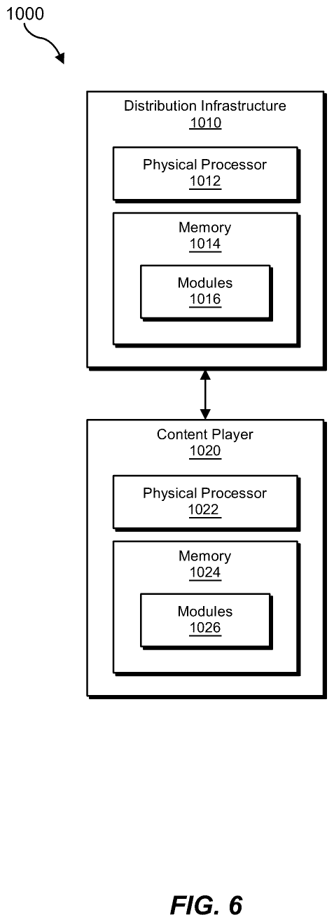

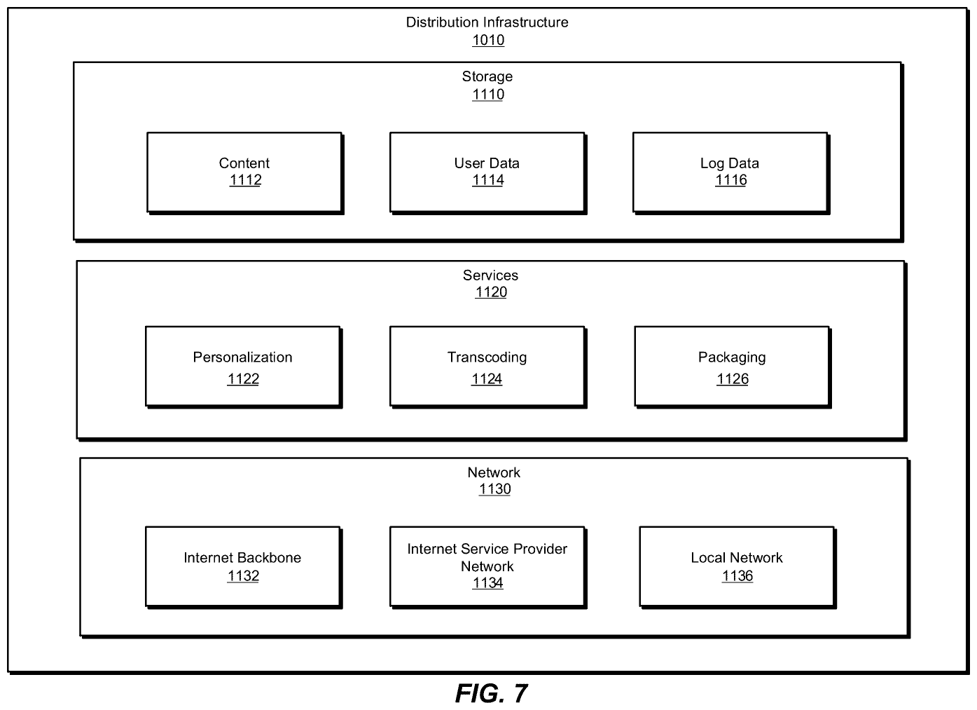

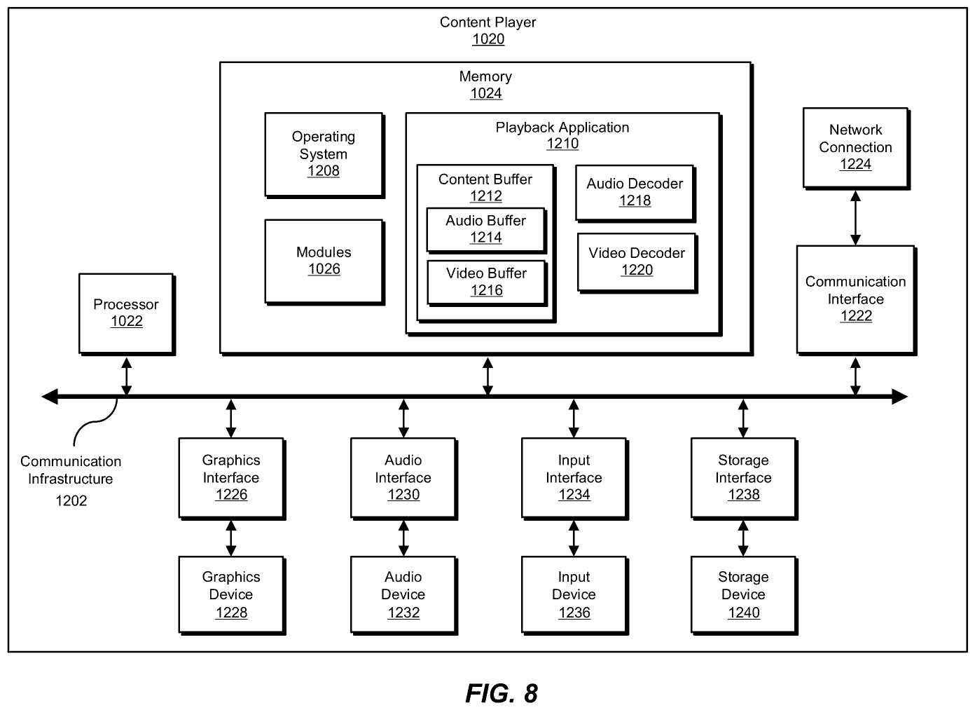

The following will provide, with reference to FIG. 6, detailed descriptions of exemplary ecosystems in which content is provisioned to end nodes and in which requests for content are steered to specific end nodes. The discussion corresponding to FIGS. 7 and 8 presents an overview of an exemplary distribution infrastructure and an exemplary content player used during playback sessions, respectively. These exemplary ecosystems and distribution infrastructures are implemented in any of the embodiments described above with reference to FIGS. 1-5.

FIG. 6 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 6 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 6 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Encoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 8 is a block diagram of an exemplary implementation of content player 1020 of FIG. 6. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 8, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 8 need not be present to practice the embodiments described and/or illustrated herein. The devices and subsystems referenced above are also interconnected in different ways from that shown in FIG. 8. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting an error rate of requests for at least one service in a specific region of a network;
determining that the error rate exceeds a threshold in the specific region of the network; and
in response to determining that the error rate exceeds the threshold, automatically shifting traffic associated with the at least one service from the specific region to at least one additional region of the network.

2. The computer-implemented method of claim 1, wherein automatically shifting the traffic from the specific region to the at least one additional region comprises rerouting the traffic to a plurality of additional regions.

3. The computer-implemented method of claim 2, wherein automatically shifting the traffic from the specific region to the at least one additional region comprises balancing the traffic across the plurality of additional regions.

4. The computer-implemented method of claim 1, wherein detecting the error rate of requests comprises detecting a certain amount of retry attempts for the at least one service.

5. The computer-implemented method of claim 4, further comprising throttling the retry attempts in response to determining that the error rate exceeds the threshold.

6. The computer-implemented method of claim 4, wherein:
the traffic associated with the at least one service comprises lower-priority traffic and higher-priority traffic; and
throttling the retry attempts comprises throttling retry attempts associated with the lower-priority traffic.

7. The computer-implemented method of claim 6, wherein throttling the retry attempts associated with the lower-priority traffic comprises throttling the retry attempts associated with the lower-priority traffic without throttling retry attempts associated with the higher-priority traffic.

8. The computer-implemented method of claim 1, further comprising tracking error rates of requests across a plurality of regions of the network, wherein the plurality of regions of the network comprises the specific region of the network.

9. The computer-implemented method of claim 8, further comprising determining the threshold in the specific region based at least in part on the error rates of requests across the plurality of regions of the network.

10. The computer-implemented method of claim 8, wherein each region of the network comprises a plurality of availability zones or data centers that support high availability of the at least one service.

11. The computer-implemented method of claim 1, wherein the requests comprise application programming interface (API) requests for the at least one service.

12. The computer-implemented method of claim 1, wherein the traffic associated with the at least one service comprises lower-priority traffic and higher-priority traffic; and
further comprising:
automatically shifting the lower-priority traffic from the specific region to the at least one additional region; and
maintaining the higher-priority traffic in the specific region despite the error rate exceeding the threshold.

13. The computer-implemented method of claim 1, further comprising:
calculating estimates of latencies likely to result from shifting the traffic from the specific region to a plurality of regions of the network, wherein the plurality of regions comprises the at least one additional region;
identifying, within the estimates of latencies, an estimate associated with latency likely to result from shifting the traffic from the specific region to the at least one additional region;
determining that the estimate associated with the latency satisfies an acceptable-latency threshold; and
in response to determining that the error rate exceeds the threshold and that the estimate associated with the latency satisfies the acceptable-latency threshold, automatically shifting the traffic associated with the at least one service from the specific region to the at least one additional region.

14. A system comprising:
at least one interface communicatively coupled to a specific region of a network; and
circuitry communicatively coupled to the interface, wherein the circuitry is configured to:
detect, via the interface, an error rate of requests for at least one service in the specific region of the network;
determine that the error rate exceeds a threshold in the specific region of the network; and
automatically shift traffic associated with the at least one service from the specific region to at least one additional region of the network in response to determining that the error rate exceeds the threshold.

15. The system of claim 14, wherein automatically shifting the traffic from the specific region to the at least one additional region comprises rerouting the traffic to a plurality of additional regions.

16. The system of claim 15, wherein automatically shifting the traffic from the specific region to the at least one additional region comprises balancing the traffic across the plurality of additional regions.

17. The system of claim 14, wherein detecting the error rate of requests comprises detecting a certain amount of retry attempts for the at least one service.

18. The system of claim 17, wherein the circuitry is further configured to throttle the retry attempts in response to determining that the error rate exceeds the threshold.

19. The system of claim 17, wherein:
the traffic associated with the at least one service comprises lower-priority traffic and higher-priority traffic; and
the circuitry is further configured to throttle retry attempts associated with the lower-priority traffic.

20. A non-transitory computer-readable medium comprising one or more computer-executable instructions that, when executed by at least one processor of a computing device, cause the computing device to:
detect an error rate of requests for at least one service in a specific region of a network;
determine that the error rate exceeds a threshold in the specific region of the network; and
in response to determining that the error rate exceeds the threshold, automatically shift traffic associated with the at least one service from the specific region to at least one additional region of the network.
